(19) United States
(12) Patent Application Publication
(10) Pub. No.: US 2002/0093658 A1
(43) Pub. Date: Jul. 18, 2002

(54) Portable dual frequency photoacoustic spectrometer

(76) Inventor: Tao Han, Solon, OH (US)

Correspondence Address: PEARNE & GORDON LLP, 526 SUPERIOR AVENUE EAST, SUITE 1200, CLEVELAND, OH, 44114-1484, US

(21) Appl. No.: 09/997,581

(22) Filed: Nov. 29, 2001

Related U.S. Application Data
(60) Provisional application No. 60/250,216, filed on Nov. 30, 2000.

(51) Int. Cl. G01N 21/59

(52) U.S. Cl. 356/432

(57) ABSTRACT

A photoacoustic spectrometer cell includes a specimen chamber having a specimen port, an optical window in optical communication with the chamber, a microphone in acoustic communication with the chamber, and a push-on closure for closing the port. At least one of the closure and the port have a groove adapted to relieve pressure in the chamber during closing.

### CROSS-REFERENCE TO RELATED APPLICATION

This application claims the benefit of U.S. Provisional Patent Application Serial No. 60/250,216 filed Nov. 30, 2000.

### BACKGROUND OF THE INVENTION

The present invention relates to a photoacoustic spectrometer and, in particular, to a photoacoustic spectrometer for measuring the characteristics of living plants.

The photosynthesis process encounters two groups of biochemistry reactions, one is light reaction and the other is dark reaction. In light reaction, absorbed light energy is used to split water molecules, producing protons and electrons and forming oxygen molecules. The electrons are transferred between a series of molecules that form an electron transferring train. With the electron translocation, high-energy molecules are formed to energize dark reaction that consumes carbon dioxide molecules and protons to synthesize sugars.

After light is absorbed by leaves, the major potion of absorbed light energy is converted to heat, at the same time, most of the remaining absorbed light is used by the photosynthesis process. A minor potion of absorbed light is re-radiated as fluorescence. Measurements of CO₂ (consumed), O₂ (evolved) and fluorescence (re-radiated) are three major methods used in photosynthesis study of leaves in vivo. CO₂ gas exchange and fluorescence techniques have become traditional methods for photosynthesis research. However, it is hard to obtain more detailed information by using both of the techniques because there are other electron bypass ways where the electrons are not ultimately consumed by CO₂ reduction, for example, photorespiration or Mehler reaction.

The major advantage of the photoacoustic (PA) technique is that it can sense the signal generated by either photothermal or photobaric effects. If a photosythetically active sample is illuminated with periodical light pulses, both its oxygen evolution and thermal release will be modulated at the same frequency as the light source, which are both PA signals and can be sensed by a microphone. With a lock-in amplifier processing signals from the microphone, only the signal modulated at a determinated frequency and having a certain phase angle can be amplified. With this method, oxygen evolution from the sample can be distinguished from existing ambient oxygen within a chamber.

U.S. Pat. No. 4,533,252 to Cahen et al. and U.S. Pat. No. 6,006,585 to Forester are incorporated herein by reference.

### SUMMARY OF THE INVENTION

A photoacoustic spectrometer cell includes a specimen chamber having a specimen port, an optical window in optical communication with the chamber, a microphone in acoustic communication with the chamber, and a push-on closure for closing the port. At least one of the closure and the port have a groove adapted to relieve pressure in the chamber during closing.

A photoacoustic spectrometer cell includes a specimen chamber having a specimen port, an optical window in optical communication with the chamber, a microphone in acoustic communication with the chamber, and a push-on closure for closing the port. At least one of the closure and the port have a groove adapted to relieve pressure in the chamber during closing. The spectrometer also includes a light source adapted to communicate with the window, and a controller. The controller is adapted to operate the light source concurrently at a first frequency and a second frequency and to process a signal from the microphone with respect to said first frequency and with respect to said second frequency.

### BRIEF DESCRIPTION OF THE DRAWINGS

FIG. 1 is a schematic block diagram of a spectrometer according to the invention.

FIG. 2 is a schematic diagram of a PA spectrometer cell according to the invention.

FIG. 3 is a perspective view of a PA spectrometer cell according to the invention.

FIG. 4 is a perspective view with portions cut away of a PA spectrometer cell body according to the invention.

FIG. 5 is a top plan view of a PA spectrometer cell body according to the invention.

FIG. 6 is a perspective view of a PA spectrometer cell closure according to the invention.

FIG. 7 is a top plan view of a PA spectrometer cell closure according to the invention.

FIG. 8 is a bottom plan view of a PA spectrometer cell closure according to the invention.

FIG. 9 is a light source and light pipe according to the invention.

FIG. 10 is a perspective view of a PA spectrometer cell body in a vibration reducing unit according to the invention.

### DESCRIPTION OF THE PREFERRED EMBODIMENTS

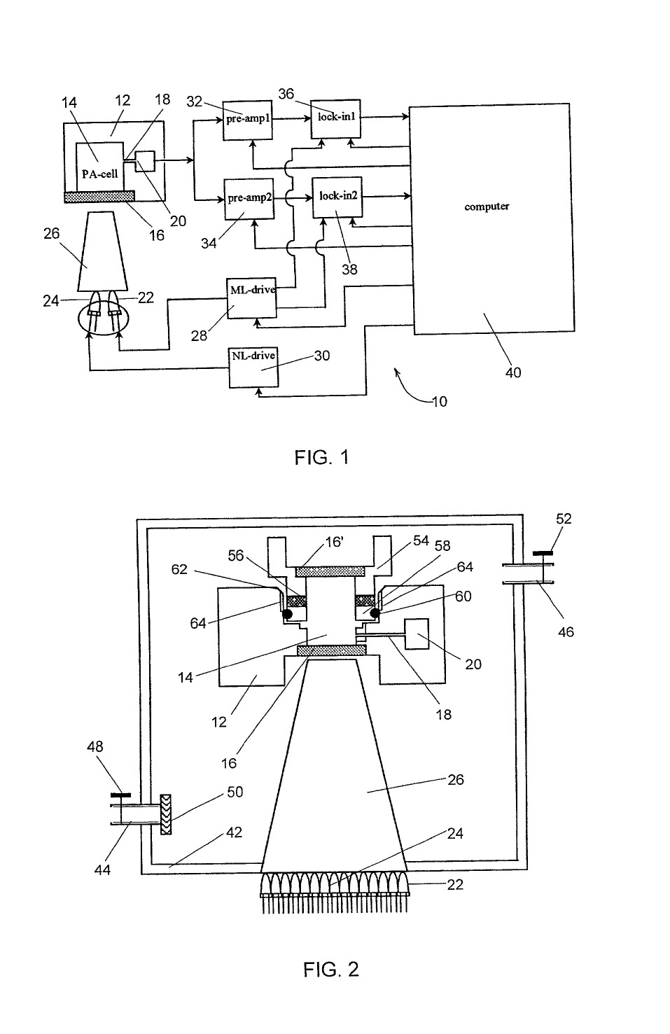

Referring to FIG. 1, a photoacoustic spectrometer 10, includes a photoacoustic spectrometer cell 12 having a body 13, a chamber 14, an optical window 16, an acoustic passage 18 and a microphone 20. The body 13 may be constructed, for example, from metal, high density plastic, or other strong, durable, material. The window 16 may be, for example, sapphire, glass or other durable material transparent to the wavelength of interest.

Light sources 22, 24 are in optical communication with a light pipe 26 for illuminating the window 16. The light sources 22, 24 may be, for example LEDs or other easily modulated light sources. The light pipe 26 may be, for example, glass or plastic, but a lens system can used instead.

The light sources 22, 24 are driven by a modulated driver 28 and a non-modulated driver 30, respectively. The drivers 28, 30 may be, for example, electrically controlled switching/modulating devices such as solid state switches or waveform synthesizers. The drivers 28, 30 may be connected to an unshown power supply as a source of power for the light sources 22, 24.

The microphone 20 provides a signal to pre-amplifiers 32, 34, which amplify the microphone signal. The pre-amplifiers 32, 34 may also include bandpass filters for respective frequencies of interest.

The amplified microphone signals are provided to respective lock-in amplifiers 36, 38. The amplifiers 32, 34 are lock-in amplifiers as are well-known in the art. The amplifiers receive synchronizing signals from the modulated driver 28.

A controller 40 controls the operation of the spectrometer 10 by providing control signals (e.g., to control light level and modulation) to the drivers 28, 30 and control signals to the lock-in amplifiers 36, 38 (e.g., phase and time constant). The controller 40 also processes that signals from the amplifiers 36, 38 to provide the desired measurements. The controller 40 may be, for example, a general purpose computer such as a laptop computer or a specialized instrument such as the combination of a programmable controller, and a display and/or a data capture device.

Referring to FIG. 2, the cell 12 can be advantageously enclosed in an environmental enclosure 42 that permits controlling the ambient gas about the cell 12 with a gas inlet 44 and a gas outlet 46. The inlet 44 has a valve 48 and a filter 50. The outlet 46 has a valve 52. The inlet 44 can be connected to an unshown gas source.

The chamber 14 is closed by a closure 54 applied to the body 13. The closure 54 has an optical window 16′ in optical communication with the chamber 14 similar to the window 16. An optional gas permeable member 56 provides a path for ambient gas into the chamber 14. A gasket retaining member 58 retains a gasket 60 on the closure 54. The gasket 60 provides a seal between the body 13 and the closure 54 and, may also, serve to frictionally retain the closure 54 on the body 13.

In the embodiment shown, the body 13 is provided with a beveled edge 62 that assists in aligning the closure 54 for insertion into body 54. Pressure relief grooves 64 are provided in the body 13 to help avoid a piston/cylinder compression effect when inserting the closure 54. Such compression effect could otherwise cause the closure 54 to pop off the body 13.

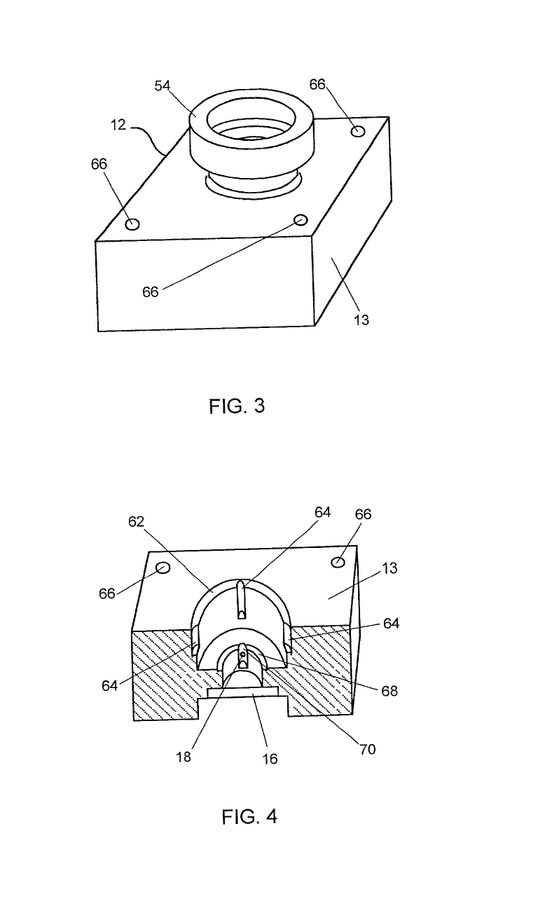

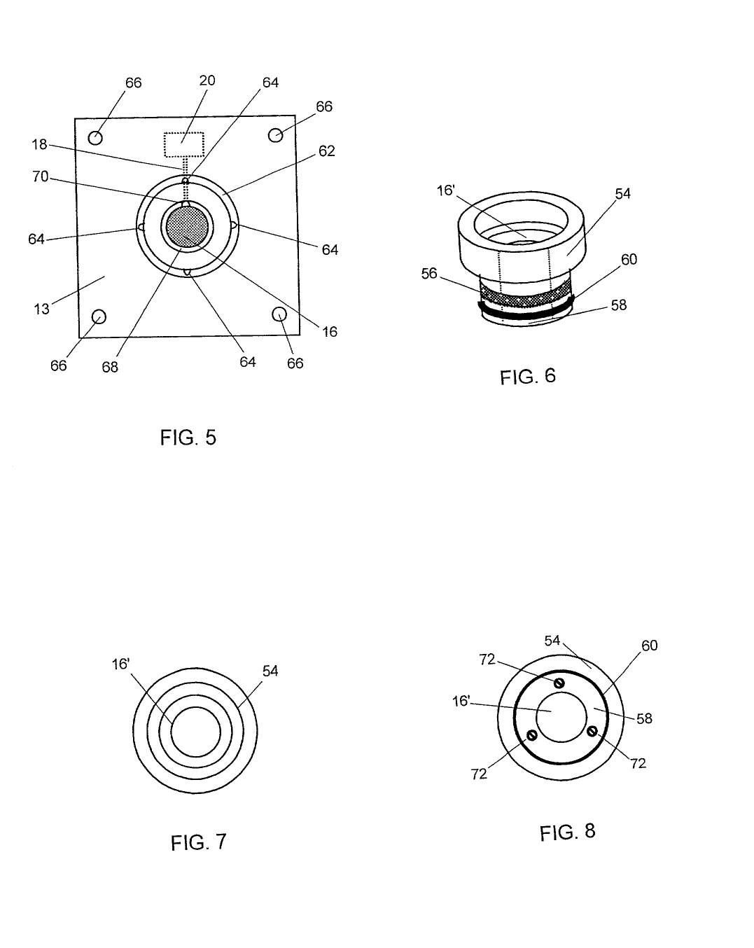

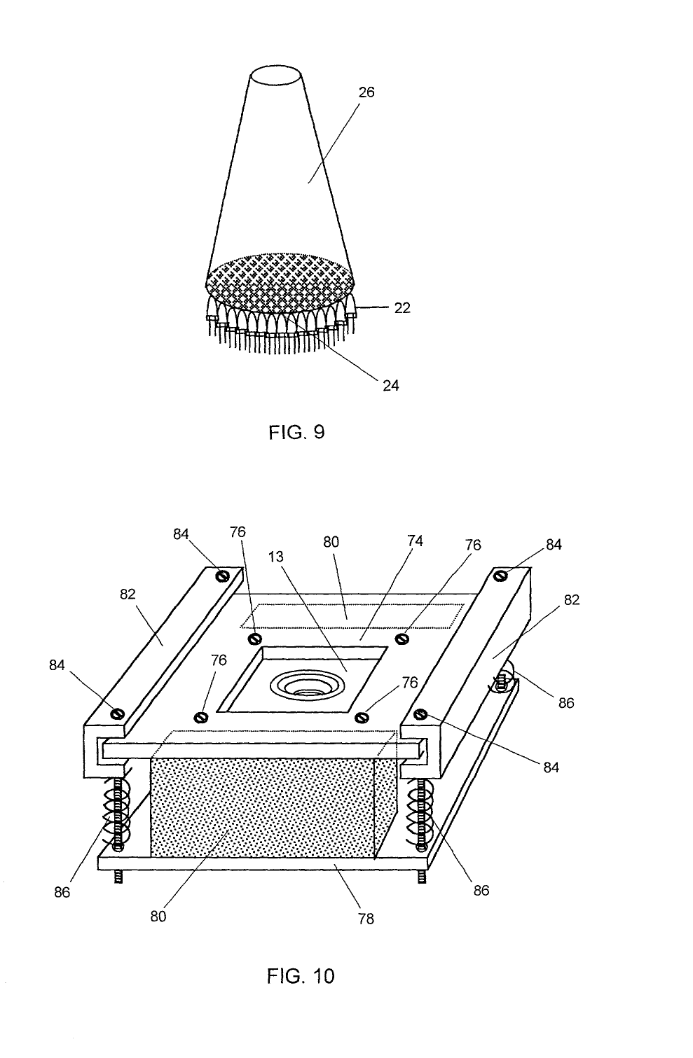

Referring to FIGS. 3, 4 and 5, the body 13 may, for example include mounting holes 66. The bottom of the chamber 14 may also include, for example, a ledge 68 to support a round disk (unshown) cut from, for example, a plant leaf. A relief groove 70 provides a gas path around the disk.

Referring to FIGS. 6, 7 and 8, the gasket 60 may be, for example, an elastomer o-ring and the retaining member 58 can include a groove for retaining the o-ring on the closure 54. Similar to the body 13, the closure 54 can be constructed, for example, from metal, high density plastic, or other strong, durable, material.

The gas permeable member 56 can be included if it is desired to control the gas constituents within the chamber 14, otherwise, a non-permeable member can be used. The components of the closure 54 can be, for example, assembled with screws 72.

The light sources 22, 24 may be advantageously composed of an array of many LEDs with, for example, half being the light source 22 and half being the light source 24, all evenly dispersed. The light pipe 26 can then be advantageously formed, for example, from a frustoconical piece of glass or plastic that focus the light onto the window 16.

Referring to FIG. 10, the body 13 may be shock mounted for portable use. The body is mounted to a plate 74 with screws 76. The plate 74 is mounted to the baseplate 78 by spongy material 80. U-shaped members 82 provide limits to the movement of the plate 74. Screws 84 and springs 86 provide adjustment for the members 82.

In operation, a sample is placed in the chamber 14 and the closure 54 pushed on the body 13. Constant light is applied by the source 24 and modulated light is applied by the source 22. The source 22 may be advantageously modulated at two frequencies concurrently. The first frequency may be, a low frequency, e.g., 1-100 Hz and the second frequency a high frequency, e.g., 100-10,000 Hz. The frequencies may be, for example, 3 Hz and 480 Hz.

The microphone 20 provides a signal in response to the applied light and the lock-in amplifiers 36, 38 then provide a respective signal corresponding to the high frequency and the low frequency. Control of the operation is by the controller 40. The controller 40 processes that signals from the amplifiers 36, 38 to provide the output of the spectrometer.

The spectrometer 10 may be used to provide dual-frequency-operation. The spectrometer 10 may employ a gas-permeable PA cell. It can be used with a special optical focusing design for ultra strong light obtained from an LED array. This makes it convenient the PA technique to be used in the field. This invention provides an ideal device for use in the fields of plant physiology, ecology, agronomy, crop screening and environmental stress monitoring.

Operating in a dual-frequency mode, makes the device work more effectively, measurements of oxygen evolution and energy storage can be conducted simultaneously. This is not only faster, but also the data is more consistent.

The easily removable closure 54, making replacement of samples easy and fast. Two types of closures are available, one with a gas-permeable material and the other without. Depending on experimental requirements, it is easy to make the photoacoustic cell either gas-permeable or not.

Experiments with a gas-permeable photoacoustic cell can provide more information about the photosynthesis process. If the outer housing is flushed with gas that has a high CO₂ content, photorespiration will be suppressed. While, if the outer housing is flushed with gas that has a low O₂ content, Mehler reaction will not occur. Using this novel instrument, we can evaluate the photosynthetic electron pathway by measuring light response curves under different gas combinations.

The novel light focusing system makes it more convenient to use an LED array as a light source for photoacoustic measurements of photosynthetic tissues in the field. Advantages of using an LED as a light source are: (1) it draws a much lower current than traditional light sources; (2) it is modulated electrically rather than mechanically since mechanic light chopper is difficult in carrying out measurements in the field; (3) it causes no worry about UV or IR comparing traditional light sources that must be equipped with optical filters to purify their spectrum output.

The whole system can be built in a small instrument case about 9″×4″×5″, not including the power supply (e.g., batteries) and the computer.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A photoacoustic spectrometer cell, said cell comprising:
a specimen chamber having a specimen port;
an optical window in optical communication with said chamber;
a microphone in acoustic communication with said chamber; and
a push-on closure for closing said port, at least one of said closure and said port having a groove adapted to relieve pressure in said chamber during said closing.

2. A cell according to claim 1, further comprising a light-concentrating light pipe in communication with said window.

3. A cell according to claim 1, wherein said closure includes a gas permeable portion.

4. A photoacoustic spectrometer, said spectrometer comprising:
a specimen chamber having a specimen port;
an optical window in optical communication with said chamber;
a microphone in acoustic communication with said chamber;
a push-on closure for closing said port, at least one of said closure and said port having a groove adapted to relieve pressure in said chamber during said closing;
a light source adapted to communicate with said window; and
a controller, said controller being adapted to operate said light source concurrently at a first frequency and a second frequency and to process a signal from said microphone with respect to said first frequency and with respect to said second frequency.

5. A spectrometer according to claim 4, further comprising a light-concentrating light pipe in communication between said light source and said window.

6. A spectrometer according to claim 4, wherein said closure includes a gas permeable portion.
